(19) United States
(12) Patent Application Publication
(10) Pub. No.: US 2008/0201634 A1
(43) Pub. Date: Aug. 21, 2008

(54) SYSTEM AND METHOD FOR CUSTOMIZING A USER INTERFACE

(76) Inventors: Erik W. Gibb, San Francisco, CA (US); Micah Laaker, Mountain View, CA (US); Matthew McAlister, San Francisco, CA (US); H. Scott Roy, Palo Alto, CA (US)

Correspondence Address: YAHOO! INC.;C/O DREIER LLP, 499 PARK AVENUE, NEW YORK, NY, 10022, US

(21) Appl. No.: 11/676,728

(22) Filed: Feb. 20, 2007

(51) Int. Cl. G06F 17/00; G06F 17/30; G06F 3/048

(52) U.S. Cl. 715/256; 715/822; 707/3

(57) ABSTRACT

Described is a system and method for customizing a user interface. A method according to one embodiment of the present invention comprises receiving a given content item and scoring the given content item. When the score exceeds a threshold, at least a portion of the given content is highlighted. The given content item is displayed with at least the portion of the given content item highlighted.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD OF THE INVENTION

The invention disclosed herein relates generally to customizing a user interface. More specifically, the present invention relates to identifying portions of data, e.g., links, within a content item relating to one or more topics or interests of a given user and highlighting or otherwise identifying the portions of data on the user interface.

### BACKGROUND OF THE INVENTION

Web sites, e.g., web portals, attract visitors by presenting content items (e.g., news stories, product offers, etc.) or providing services (e.g., search engine, email, fantasy sports, etc.). Due to an ever-increasing amount of content available on the Internet (and in private networks) and various websites, web portals may distinguish themselves by providing both general and customized interfaces for visitors. For example, a visitor may indicate an interest in various topics, such as the New York Knicks® and U.S. foreign policy, whereby the web portal creates a customized interface for the visitor consisting of content items related to the indicated topics.

Conventionally, the customized interface is arranged so that the content items about topics that the user indicates are presented at a top-most portion, being immediately visible when the customized interface is loaded, thereby not requiring the visitor to scroll the page. While the content items may be immediately visible, the visitor may become confused, because the customized interface looks different from a general interface with which the visitor is presented upon an initial visit to the web portal. Continuing with the prior example, the content items related to the Knicks may be at the top-most portion of the customized interface which corresponds to a location for News content items on the general interface, or the customized interface may not include general sections (e.g., News, Sports) but rather post a list of content items including data related to the indicated topics.

Thus, there exists a need to provide a customized interface for visitors which is substantially similar to the general interface of a given web site.

### SUMMARY OF THE INVENTION

Embodiments of the present invention are directed towards systems and methods for customizing a user interface, e.g., the presentation of a content item. A method according to one embodiment of the invention comprises receiving a given content item and scoring the given content item. When the score for the given content item exceeds a threshold, at least a portion of the given content item is highlighted and the given content item is displayed with at least the portion of the given content item. Accordingly, the method of the present embodiment allows for portions of a content item to be highlighted or otherwise called out without rearranging or otherwise reordering the content item, thereby providing the user with a consistent interface experience.

The method may further comprise displaying at least the portion of the content item prior to the highlighting. Accordingly, the given content item may have a first visual format before the highlighting and a second visual format after the highlighting. Alternatively, or in conjunction with the foregoing, the first and second visual formats are the same. The highlighting may comprise modifying a display attribute of the portion of the content item, which may include at least one of a color, a font and a font size. Highlighting may also or alternatively comprise displaying an icon adjacent to the portion of the content item, placing the portion of the content item in a top-most position of the given content item. The method may further comprise reordering portion of the content item within the given content item, which may comprise placing the portion of the content item at a beginning of the given content item.

Highlighting of the given content item may be made upon the request of the user. For example, the highlighting may be executed upon receipt of an activation signal. Upon receipt of a deactivation signal, the highlight of the portion of the content item may be removed. Activation and deactivation, as well as other steps of embodiments of the method of the present invention may be performed at a server, at a client device, e.g., through the use of toolbar program code, or combinations thereof. A model for scoring the at least one content item may be stored in a profile for a user, which may reside locally, remotely or combinations thereof, e.g., a distributed profile.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 shows an exemplary embodiment of a system for customizing a user interface according to one embodiment of the present invention;

FIG. 2 shows an exemplary embodiment of a general interface according to one embodiment of the present invention;

FIG. 3 shows an exemplary embodiment of a customized interface according to one embodiment of the present invention;

FIG. 4 shows an exemplary embodiment of a method for generating a customized interface according to one embodiment of the present invention;

FIG. 5 shows an exemplary embodiment of a method for selectively activating and deactivating a customized interface according to one embodiment of the present invention; and

FIG. 6 shows an exemplary embodiment of a method for re-organizing links to content items in a given content item according to one embodiment of the present invention.

### DETAILED DESCRIPTION OF THE PREFERRED EMBODIMENTS

In the following description of the preferred embodiments, reference is made to the accompanying drawings that form a part hereof, and in which is shown by way of illustration exemplary embodiments in which the invention may be practiced. It is to be understood that other embodiments may be utilized and structural changes may be made without departing from the scope of the present invention.

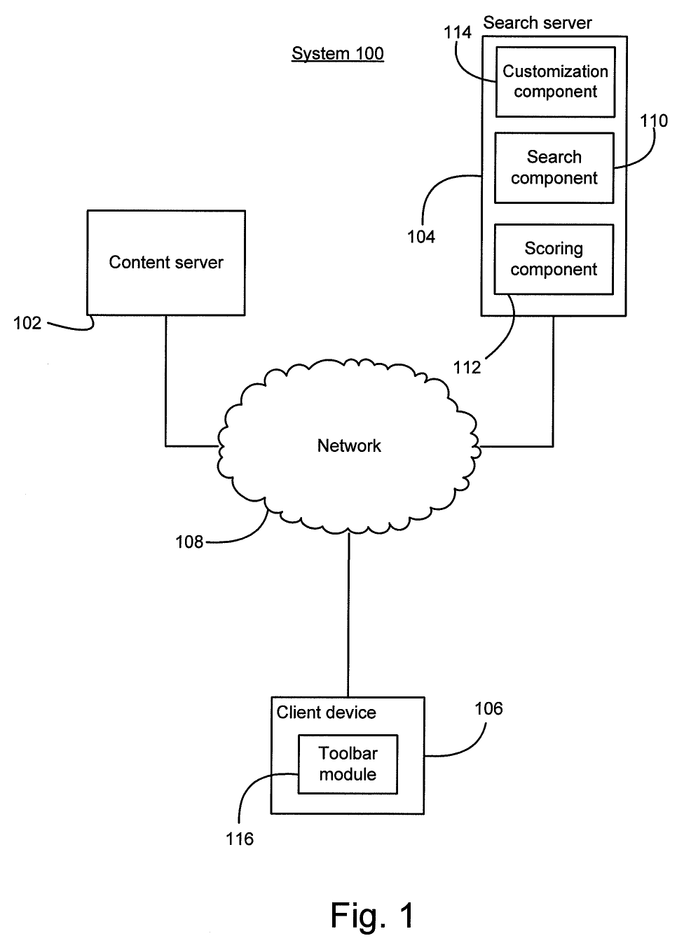

FIG. 1 shows an exemplary embodiment of a system 100 for customizing a user interface according to the present invention. The system 100 may comprise a content server 102, a search server 104 and a client device 106 which are communicatively interconnected via a communications network 108 (e.g., a wired/wireless LAN/WAN, a cellular network, the Internet, an intranet, a VPN, a PSTN, etc.). The content and search servers, 102 and 104, respectively, and the client device 106, may be processor-based computing devices which include memory and network connection ports for communicating data on the network 108. For example, the client device 106 may be a PC, laptop, mobile phone, PDA, tablet computer, handheld computer, smart appliance (e.g., scanner, copier, facsimile machine), etc. which utilizes a web browser (or command-line interface) for allowing a user to interface with devices on the network 108. Those of skill in the art understand that any number and type of client devices 106 may be connected to the network 108.

In the exemplary embodiment of FIG. 1, the content server 102 maintains one or more content items (e.g., audio, video, image and text content items, as well as combinations thereof), making the one or more content items available to devices on the network 108. In other exemplary embodiments, the content items may be stored on databases coupled to the network 108 or directly to the search server 104, the client device 106, other networked devices, etc. The content items may include text data, video data or audio data, including combinations thereof, and be embodied as, for example, web pages, emails, advertisements, news stories, RSS feeds, digital images, digital videos, digital music, etc. According to one embodiment, the content server 102 may be operated by and host a website for a news organization displaying and/or containing links to the content items. As understood by those of skill in the art, the system 100 may include any number of content servers 102 connected to the search server 104 directly or via the network 108.

The search server 104 may be operated by a web portal company (e.g., Yahoo!, Inc.®), a given exemplary web portal including services such as a search engine, email, news, bulletin boards, online shopping, fantasy sports, P2P messenger, etc. As understood by those of skill in the art, the web portal may generate and provide original content items in conjunction with the content items generated by the content server 102. According to one exemplary embodiment, the news organization may have an agreement with the web portal company allowing the web portal to provide links to the content items that the content server 102 maintains.

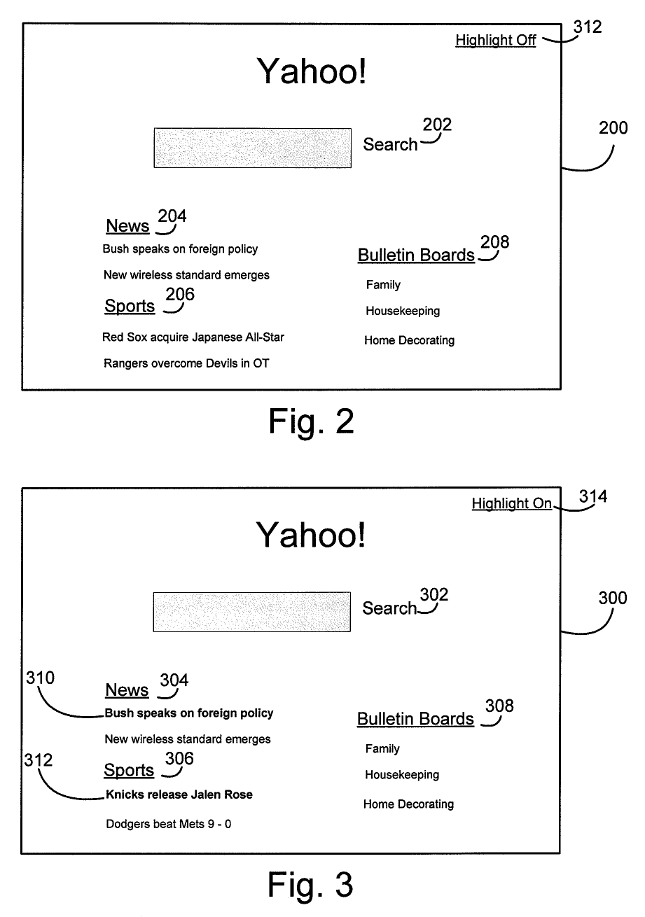

Upon an initial visit to an exemplary web portal, the portal may present users with a general interface 200, as shown in FIG. 2. The general interface 200 provides services (e.g., a search engine 202), as well as links to content items (e.g., News 204, Sports 206, Bulletin Boards 208, videos, images, etc.) which are available for viewing by users of the web portal. As understood by those of skill in the art, the links to content items that the general interface 200 presents may reflect a set of recent content items generated by the content server(s) 102 or the search server 104. In another exemplary embodiment, the links to content items that the general interface 200 presents may be those content items that users access the most at the web portal over a given period of time.

A ranking system may be utilized which ranks the content items based on a number of times each respective content item is accessed over a time for that the content item is viewed. The content items having the highest rankings may be displayed on the general interface 200 (or on top of a list of the content items). Because the links to content items that the general interface 200 presents may be selected based on time (e.g., when created), aggregate access (e.g., by multiple visitors), or other functions, the visitor may be required to navigate through several pages of the web portal to reach the content items relating to desired topics. For example, if the visitor wants to read recent stories about the Knicks, a path through pages of the web portal may be: General/Home→Sports→NBA→Teams→Knicks.

Referring back to FIG. 1, the search server 104 may implement a search component 110 (e.g., crawler, spider) that identifies the content items, a scoring component 112 for determining scoring content items with regarding as to whether a given content items is personally relevant to topics in which the user expresses an interest. The search server may further implement a customization component 114 that utilizes the scores output by the scoring component to customize an interface for a content item, e.g., a portal web page. In the exemplary embodiment, the scoring component 112 utilizes a machine learning algorithm that extracts rules or patterns from a plurality of labeled content items (e.g., training data) to generate and optimize a scoring model that may be used to score unlabeled content items. The machine learning algorithm used by the search server 104 may be that which is described in commonly owned U.S. application Ser. No. ______, entitled “System and Method for Classifying a Content Item,” and assigned attorney docket no. 600189.437, the disclosure of which is hereby incorporated by reference herein in its entirety. Those of skill in the art understand that other classification models or algorithms may be utilized, such as a neural network, k-Nearest Neighbor, support vector machines, etc.

When searching over and scoring a plurality of the unlabeled content items, the scoring component 112 may score a given one of the unlabeled content items, e.g., 0 when the unlabeled content item is not a match with the interests of the user and 1 when the unlabeled content item is a match with the interests of the user. The scoring component 112 may be embodied in hardware, software or any combination thereof. For example, the scoring component 112 may comprise one or more instructions stored on a computer-readable media, and a processor in the search server 104 may execute the instructions. Those of skill in the art will understand that the content server 102 may additionally or alternatively implement the machine learning algorithm as described herein.

The scoring component 112 generates scores for the one or more unlabeled content items and passes the scores as input to a customization component 114. The customization component 114 identifies links to content items in a given content item with scores above a threshold. For example, the threshold may be a confidence level such that when the score of a content item exceeds the threshold, there is a sufficient level of confidence that the content item is of interest to the user. According to one embodiment, a portal page comprises links to content items and the customization component highlights links to content items with scores exceeding the threshold. By highlighting links to the content items with scores exceeding the threshold, the customization component may modify the portal page such that the page maintains a visual format or framework that is substantially similar to the general interface, allowing the visitor to easily locate content items that are of interest to the user.

In addition to the foregoing, embodiments of the invention comprise placing some or all of the functionality described herein at the client deice 106 in a toolbar module 116 at the client device. For example, the toolbar module 116 may implement the functionality that one or more of the search component 110, scoring component 112 or the customization component 114 provides. According to one embodiment, the toolbar module 116 receives information from the scoring component 112 on the server and is operative to implement functionality of the customization component 114 to highlight a given content item that the user receives at the client device 106.

In the exemplary embodiment, a customized interface of FIG. 3 provides or distinguishes links to content items that relate to a past observed or otherwise identified behavior or interest of the user identified, e.g., a content item that is interesting to the user. The topics of interest to the user may be identified when, for example, the user registers with the web portal, by analyzing the content items accessed by the user, a browsing history of a web browser on the client device, online purchases made by the user (via the web portal or other e-commerce sites), cookies transmitted by the web browser, other data stored on the client device, etc. The topics may be used to generate a visitor profile for determining whether links to unlabeled content items should be included or distinguished on the customized interface 300.

As was the case with the generic interface of FIG. 2 that the web portal provides, the customized interface maintains a substantially similar look and feel, e.g., layout, in that the search tool 302, and various topical sections of the web site such as news 304, sports 306 and bulletin boards 308 are located in similar locations on the portal page 300. The page 300, however, identifies those items in that they are of interest to the user as identified by the scoring component and the customization component. Continuing on the prior examples, the customization component may identify links to content items regarding U.S. foreign policy 310 and the Knicks 312 in boldface type or other highlight or callout.

In the customized interface 300, the user may utilize a highlight control 314 to toggle activation and deactivation of the highlight. The customization component may identify links to content items that are of interest to the user 310 and 312 on the basis of a display attribute of the content item (or a selected portion of data contained therein). For example, the modification may include emphasized text, a larger font size relative to fonts of adjacent links to content items, a change in font color, juxtaposition of an icon (e.g., Y!) adjacent the link to the content item, a change in order/position of the link to the content item relative to adjacent links, etc. Additionally, the highlight 310 and 312 may be adjusted based on satisfaction of multiple thresholds. For example, a link to a content item with a score of 0.95 may be presented using a substantially larger font than a link to a content item with a score of only 0.75.

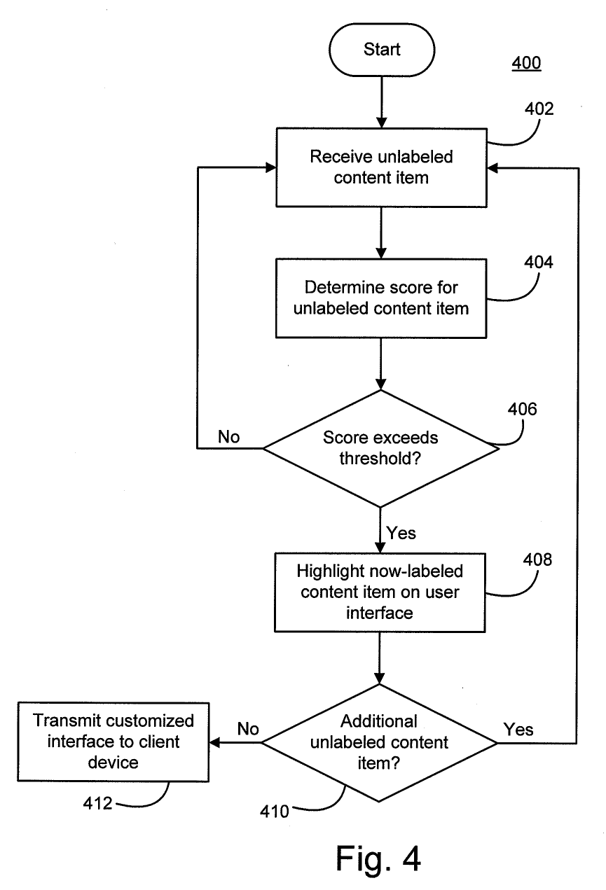

FIG. 4 illustrates a method 400 for customizing a user interface according to one embodiment of the present invention. In step 402, an unlabeled content item is received. As stated above, the unlabeled content item may be generated by the content server, the search server or other devices in communication with the network. While the exemplary embodiment is described with reference to the search server implementing the method 400, those of skill in the art understand that the content server 102 may execute the method 400, or the servers 102, 104 may execute the method 400 (or predetermined steps thereof) in parallel, e.g., a distributed system.

In step 404, a score is determined for the unlabeled content item by, for example, inputting the unlabeled content item into the scoring model utilized by the scoring component, although those of skill in the art recognize that the method may use other models or algorithms. If the score falls below a threshold, step 406, the content item may be ignored and a further unlabeled content item may be analyzed, step 402. Where the score of the content item exceeds the threshold, step 406, a link to the content item that the customized interface displays may be presented in bold, highlight or otherwise emphasized, step 408. A check is performed to determine if there are additional unlabeled content items for processing, step 410, and if so, program flow returns to step 402 with the selection of a subsequent unlabeled content item. Where the check at step 410 evaluates to false, the customized interface is transmitted to the client device, step 412.

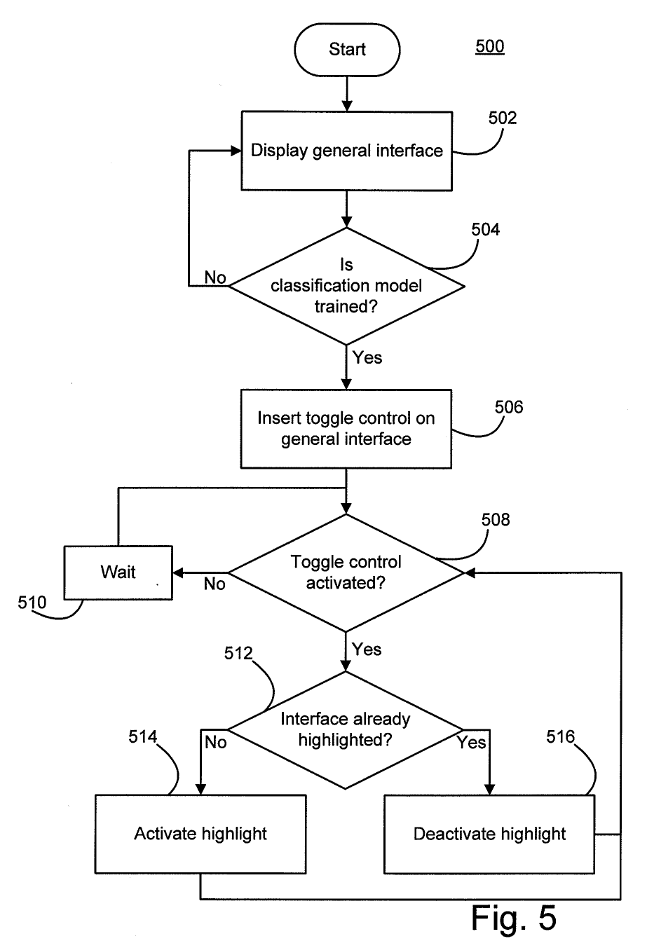

In another exemplary embodiment, the user may selectively activate the highlight or other indication in the customized interface. FIG. 5 illustrates a method 500 for activating and de-activating the highlight according to one embodiment of the present invention. In step 502, the general interface 200 is displayed. In step 504, it is determined whether the scoring model has been sufficiently trained for score unlabeled content items. For example, the scoring model iterates over a number of labeled content items before being sufficiently trained, e.g., before the scores generated thereby are trusted as accurate. As understood by those of skill in the art, accuracy of the scoring model may be tested at the search server 104 and may further be hand tuned. When the scoring model is sufficiently trained, the method 500 proceeds to step 506 in which a control may be presented on the general interface to toggle activation and deactivation of the identification of content items that the user should find interesting. The control may be represented as a link or other indicator (e.g., button, switch, etc.).

In step 508, it is determined whether the toggle control has been activated. If the toggle control has not been activated, the method goes into a wait state, step 510, which may last for a predetermined amount of time. Upon activation, step 508, a subsequent check determines if the interface is already highlighted, step 512, e.g., customized to call out links to content items interesting to the user. Where the check at step 512 evaluates to false, highlighting is applied to the interface, step 514, otherwise the highlight is deactivated, step 516. Program flow then returns to step 508.

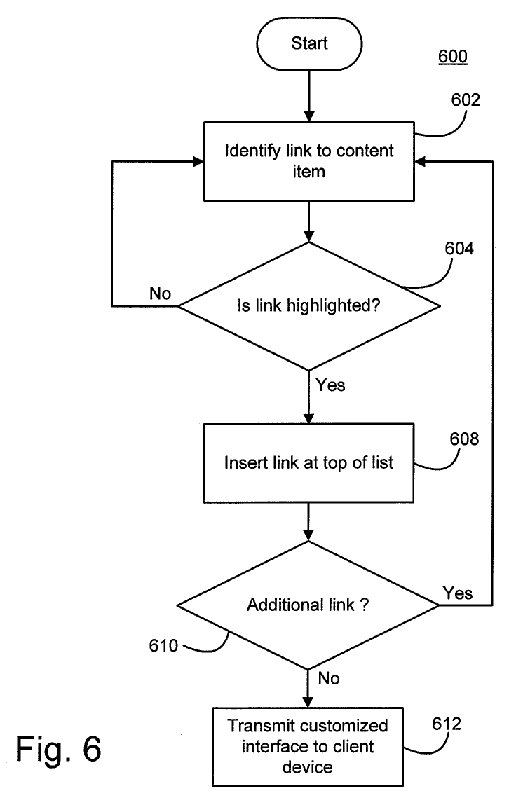

In an exemplary embodiment, links to content items may be reorganized so that the elements having the highlight are grouped together. FIG. 6 illustrates a method 600 for grouping links to content items according to one embodiment of the present invention. In step 602, a link in a given content item is selected, e.g., a link in a portal web page, search result page, etc. In step 604, it is determined whether the selected link has been identified for the application of a highlight. If not, a further link is selected by, step 602, for example, stepping through each link in a given content item, randomly selecting elements, selecting every nth element, etc.

Where the link has highlighting applied, step 604, the link may be inserted at a predetermined position (e.g., a beginning) in the content item, step 608. For example, in a search result page, the link may be placed at the top of the result set, on a separate area of the interface, etc. Similarly, for a web portal that presents links to content items according to topic, links to content items with the highlight applied may be grouped within a given topic. In this manner, all links with highlighting may be arranged in summary fashion at the beginning of a search result page, portal web page, etc. When moving more than one link, the algorithm may preserve the original pairwise order of the links that move. A check determines if additional links to content items require processing, step 610, which if true directs program flow to step 602 with the selection of a subsequent link. Where no links remain for processing, step 610, the reorganized page, e.g., customized interface, may be transmitted to the client device, step 612, an may also be stored on the search server, a database, etc.

FIGS. 1 through 6 are conceptual illustrations allowing for an explanation of the present invention. It should be understood that various aspects of the embodiments of the present invention could be implemented in hardware, firmware, software, or combinations thereof. In such embodiments, the various components and/or steps would be implemented in hardware, firmware, and/or software to perform the functions of the present invention. That is, the same piece of hardware, firmware, or module of software could perform one or more of the illustrated blocks (e.g., components or steps).

In software implementations, computer software (e.g., programs or other instructions) and/or data is stored on a machine readable medium as part of a computer program product, and is loaded into a computer system or other device or machine via a removable storage drive, hard drive, or communications interface. Computer programs (also called computer control logic or computer readable program code) are stored in a main and/or secondary memory, and executed by one or more processors (controllers, or the like) to cause the one or more processors to perform the functions of the invention as described herein. In this document, the terms “machine readable medium,” “computer program medium” and “computer usable medium” are used to generally refer to media such as a random access memory (RAM); a read only memory (ROM); a removable storage unit (e.g., a magnetic or optical disc, flash memory device, or the like); a hard disk; electronic, electromagnetic, optical, acoustical, or other form of propagated signals (e.g., carrier waves, infrared signals, digital signals, etc.); or the like.

Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

The foregoing description of the specific embodiments will so fully reveal the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s).

While various embodiments of the present invention have been described above, it should be understood that they have been presented by way of example, and not limitation. It would be apparent to one skilled in the relevant art(s) that various changes in form and detail could be made therein without departing from the spirit and scope of the invention. Thus, the present invention should not be limited by any of the above-described exemplary embodiments, but should be defined only in accordance with the following claims and their equivalents.

What is claimed is:

1. A method, comprising:
receiving a given content item;
scoring the given content item;
when the score exceeds a threshold, highlighting at least a portion of the given content item; and
displaying the given content item with at least the portion of the given content item highlighted.

2. The method according to claim 1, further comprising prior to the highlighting, displaying at least the portion of the content item.

3. The method according to claim 1, wherein the given content item has a first visual format before the highlighting and a second visual format after the highlighting.

4. The method according to claim 1, comprising executing the scoring, highlighting or displaying by a toolbar module at a client device.

5. The method according to claim 1, further comprising storing a model for scoring the at least one content item in a profile for a user.

6. The method according to claim 1, wherein the highlighting comprises modifying a display attribute of the portion of the content item.

7. The method according to claim 6, wherein the display attribute includes at least one of a color, a font and a font size.

8. The method according to claim 1, wherein the highlighting comprises displaying an icon adjacent to the portion of the content item.

9. The method according to claim 1, wherein the highlighting includes placing the portion of the content item in a top-most position of the given content item.

10. The method according to claim 1, wherein the highlighting is executed upon receipt of an activation signal.

11. The method according to claim 1, further comprising upon receipt of a deactivation signal, removing the highlight of the portion of the content item.

12. The method according to claim 1, further comprising reordering a portion of the content item within the given content item.

13. The method according to claim 12, wherein the reordering comprises placing the portion of the content item at a beginning of the given content item.
